(19) United States
(12) Patent Application Publication
(10) Pub. No.: US 2025/0046830 A1
(43) Pub. Date: Feb. 6, 2025

(54) FUEL CELL STACK

(71) Applicant: Robert Bosch GmbH, Stuttgart (DE)

(72) Inventors: Wasif Islam Chowdhury, Tokyo (JP); Moe Sakamoto, Tokyo (JP); Shigetaka Uehara, Tokyo (JP)

(21) Appl. No.: 18/836,831

(22) PCT Filed: Jan. 10, 2023
(86) PCT No.: PCT/IB2023/050191

§ 371 Date: Aug. 8, 2024

(30) Foreign Application Priority Data
Feb. 18, 2022 (JP) 2022-023359

(51) Int. Cl. H01M 8/0273; H01M 8/0284; H01M 8/248

(52) U.S. Cl. CPC H01M 8/0273; H01M 8/0284; H01M 8/248

(57) ABSTRACT

To improve sealing performance of a fuel cell stack. A fuel cell stack 1 includes: a laminated body 10 in which a plurality of fuel cells 100 are laminated, each fuel cell 100 including a membrane electrode assembly 110, and separators 120 that are disposed at both sides of the membrane electrode assembly 110; and a pair of clamping members 20 that clamp the laminated body 10 in a laminated direction D1 of the laminated body 10, in which the fuel cell 100 includes a frame portion 130 that outwardly projects from an outer peripheral portion of the membrane electrode assembly 110, an elastic seal member 50 that is elastically deformable in the laminated direction D1 is provided to the clamping member 20, the relevant elastic seal member 50 is interposed between the separator 120 that is adjacent to the clamping member 20, and the clamping member 20, the elastic seal member 70 is also provided to the frame portion 130 of at least one of the fuel cells 100 or the separator 120 that is adjacent to the relevant frame portion 130, and the relevant elastic seal member 70 is interposed between the separator 120 that is adjacent to the relevant frame portion 130, and the relevant frame portion 130.

### BACKGROUND

The present invention relates to a fuel cell stack.

In recent years, various kinds of techniques using fuel cell stacks have been proposed (for example, see JP2010-277704A). The fuel cell stack is provided with a laminated body in which a plurality of fuel cells are laminated, each fuel cell including a membrane electrode assembly that includes an anode electrode and a cathode electrode, and separators that are disposed at both sides of the membrane electrode assembly. A fuel gas (specifically, hydrogen gas) is supplied to the anode electrode, and an oxidation gas (specifically, air) is supplied to the cathode electrode to generate power.

### SUMMARY

Meanwhile, in the fuel cell stack, a flow path through which a gas to be supplied to the membrane electrode assembly circulates, and a flow path through which a refrigerant circulates are formed by the separators. Further, in order to prevent the gas and the refrigerant from leaking out from these flow paths, it is desired to improve the sealing performance (performance to seal) with respect to the gas and the refrigerant.

Therefore, in view of such problems, an object of the invention is to provide a fuel cell stack capable of improving the sealing performance of a fuel cell stack.

In order to solve the abovementioned problem, a fuel cell stack includes: a laminated body in which a plurality of fuel cells are laminated, each fuel cell including a membrane electrode assembly that includes an electrolyte membrane, an anode electrode, and a cathode electrode, and separators that are disposed at both sides of the membrane electrode assembly; and a pair of clamping members that clamp the laminated body in a laminated direction of the laminated body, in which: the fuel cell includes a frame portion that outwardly projects from an outer peripheral portion of the membrane electrode assembly, the separators being disposed at both sides of the frame portion; an elastic seal member that is elastically deformable in the laminated direction is provided to the clamping member, and the relevant elastic seal member is interposed between the separator that is adjacent to the clamping member, and the clamping member; and the elastic seal member is also provided to the frame portion of at least one of the fuel cells or the separator that is adjacent to the relevant frame portion, and the relevant elastic seal member is interposed between the separator that is adjacent to the relevant frame portion, and the relevant frame portion.

With the invention, it is possible to improve the sealing performance of the fuel cell stack.

### BRIEF DESCRIPTION OF THE DRAWINGS

FIG. 1 is a perspective view illustrating a schematic configuration of a fuel cell stack according to a first embodiment of the invention.

FIG. 2 is a cross-sectional view illustrating the schematic configuration of the fuel cell stack according to the first embodiment of the invention.

FIG. 3 is a view illustrating a separation state of the fuel cell stack according to the first embodiment of the invention.

FIG. 4 is a cross-sectional view illustrating a schematic configuration of a fuel cell stack according to a second embodiment of the invention.

FIG. 5 is a view illustrating a separation state of the fuel cell stack according to the second embodiment of the invention.

### DETAILED DESCRIPTION

Hereinafter, with reference to the attached drawings, preferred embodiments of the invention will be described in detail. The sizes, materials, other specific numerical values, and the like indicated in the embodiments are merely examples for easy understanding of the invention, and do not limit the invention unless otherwise specified. Note that, in the present description and drawings, the elements having substantially the same function and configuration are denoted by the same reference numerals and the overlapped explanation is omitted, and the illustration of the elements not directly related to the invention is omitted.

### First Embodiment

A fuel cell stack 1 according to a first embodiment of the invention will be described.

### (Configuration)

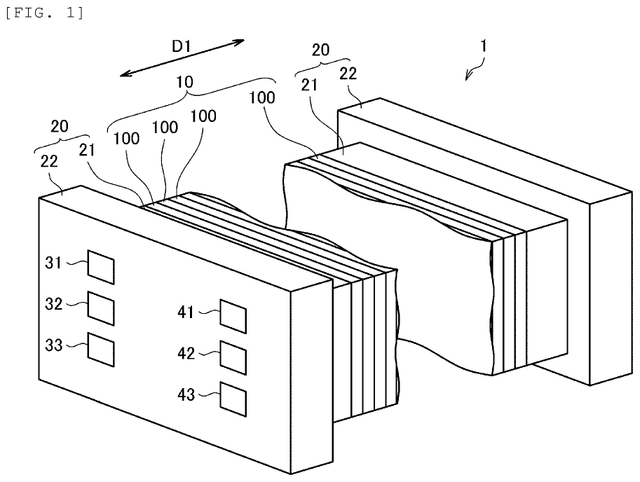

With reference to FIGS. 1 to 3, a configuration of the fuel cell stack 1 according to the first embodiment of the invention will be described.

FIG. 1 is a perspective view illustrating a schematic configuration of the fuel cell stack 1. As illustrated in FIG. 1, the fuel cell stack 1 is provided with a laminated body 10 in which a plurality of fuel cells 100 are laminated, and a pair of clamping members 20, 20.

Each of the fuel cells 100 has a substantially rectangular flat-plate shape. The plurality of such the fuel cells 100 are laminated to form the laminated body 10. The laminated body 10 has a substantially prismatic shape. In FIG. 1, a laminated direction D1 of the laminated body 10 is indicated by an arrow. The number of the fuel cells 100 in the laminated body 10 is not specially limited. Note that, details of a configuration of the fuel cell 100 are described later.

The pair of the clamping members 20, 20 are respectively disposed at both sides of the laminated direction D1 with respect to the laminated body 10. The pair of the clamping members 20, 20 clamp the laminated body 10 in the laminated direction D1. The pair of the clamping members 20, 20 are attached to the laminated body 10 by bolt-fastening, for example. Accordingly, a fastening load in the laminated direction D1 is applied to the laminated body 10.

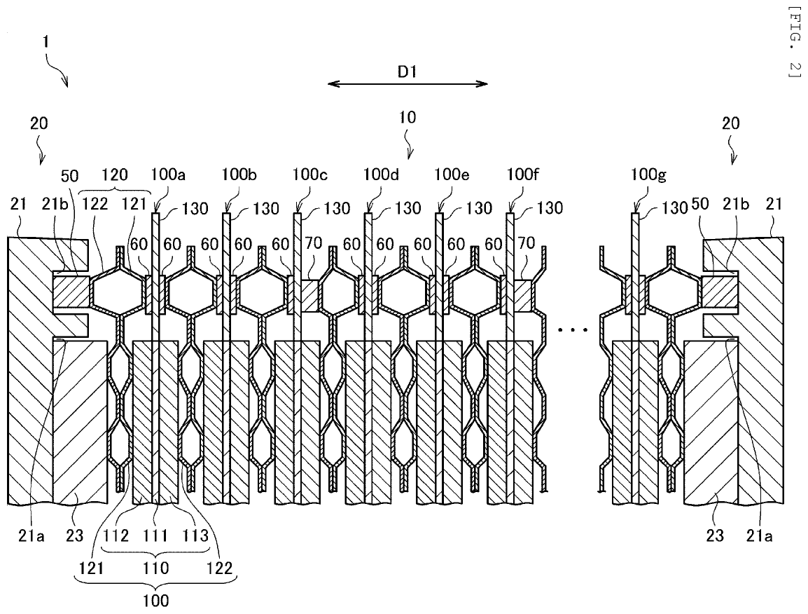

The clamping member 20 includes an insulator 21, an end plate 22, and a terminal plate 23, which is described later (see FIG. 2). The end plate 22 is disposed to an end portion in the laminated direction D1 in the fuel cell stack 1. The insulator 21 is disposed between an end portion of the laminated body 10 in the laminated direction D1 and the end plate 22. The insulator 21 is a member having an insulation property. A terminal (illustration is omitted) of the fuel cell stack 1 for connection to an external apparatus is electrically connected to the laminated body 10 via the terminal plate 23, which is described later.

In one of the end plates 22 (the end plate 22 at a near side in an example of FIG. 1), a fuel gas supply hole 31, an oxidation gas supply hole 32, a refrigerant supply hole 33, a fuel gas exhaust hole 41, an oxidation gas exhaust hole 42, and a refrigerant exhaust hole 43 are formed. These respective holes are communicated with each fuel cell 100 of the laminated body 10. Note that, the arrangement of these respective holes is not limited to that in the example of FIG. 1.

In the fuel cell stack 1, a hydrogen gas serving as a fuel gas is supplied from the fuel gas supply hole 31 to the laminated body 10, and is exhausted from the fuel gas exhaust hole 41. Moreover, the air serving as an oxidation gas is supplied from the oxidation gas supply hole 32 to the laminated body 10, and is exhausted from the oxidation gas exhaust hole 42. In each fuel cell 100 of the laminated body 10, the fuel gas and the oxidation gas are reacted with each other to generate power. Moreover, cooling water serving as a refrigerant is supplied from the refrigerant supply hole 33 to the laminated body 10, and is exhausted from the refrigerant exhaust hole 43. Each fuel cell 100 of the laminated body 10 is cooled by the refrigerant.

FIG. 2 is a cross-sectional view illustrating the schematic configuration of the fuel cell stack 1. Specifically, FIG. 2 illustrates a cross-section that passes through none of the fuel gas supply hole 31, the oxidation gas supply hole 32, the refrigerant supply hole 33, the fuel gas exhaust hole 41, the oxidation gas exhaust hole 42, and the refrigerant exhaust hole 43 to be formed in one of the end plates 22, and is parallel to a side surface (a side surface at the right side in FIG. 1) of the laminated body 10.

As mentioned above, in the laminated body 10 of the fuel cell stack 1, the plurality of the fuel cells 100 are laminated. FIG. 2 illustrates a state where fuel cells 100a, 100b, 100c, 100d, 100e, 100f, and 100g are arranged in this order. A plurality of fuel cells 100, which are not illustrated, are interposed between the fuel cell 100f and the fuel cell 100g. Note that, as mentioned above, the number of the fuel cells 100 in the laminated body 10 is not specially limited.

As illustrated in FIG. 2, the fuel cell 100 includes a membrane electrode assembly (MEA) 110, and separators 120 (specifically, an anode-side separator 121 and a cathode-side separator 122) that are disposed at both sides of the membrane electrode assembly 110.

The membrane electrode assembly 110 includes an electrolyte membrane 111, an anode electrode 112, and a cathode electrode 113. The electrolyte membrane 111 is a membrane having a property of causing hydrogen ions to pass therethrough. The anode electrode 112 and the cathode electrode 113 are opposed to each other by sandwiching the electrolyte membrane 111 therebetween, and each include, for example, a catalyst layer in which platinum or an alloy containing platinum is supported on carbon particles. More specifically, in each of the anode electrode 112 and the cathode electrode 113, a gas diffusion layer (GDL) is provided at an outer side of the catalyst layer (a side far from the electrolyte membrane 111). The anode electrode 112 is an electrode that loses electrons when power is generated, and the cathode electrode 113 is an electrode that obtains electrons when power is generated. The electrolyte membrane 111, the anode electrode 112, and the cathode electrode 113 each have a rectangular flat-plate shape, for example. Projected areas of the electrolyte membrane 111, the anode electrode 112, and the cathode electrode 113 into the laminated direction D1 are substantially the same, and the whole regions of respective surfaces of the electrolyte membrane 111 are respectively covered by the anode electrode 112 and the cathode electrode 113.

The separator 120 includes the anode-side separator 121 and the cathode-side separator 122. The anode-side separator 121 and the cathode-side separator 122 are formed of a metal material such as stainless steel or titanium, for example. The anode-side separator 121 and the cathode-side separator 122 can be obtained by press processing of a thin metal plate, for example.

The anode-side separator 121 and the cathode-side separator 122 are opposed to each other by sandwiching the membrane electrode assembly 110 therebetween. The anode-side separator 121 is opposed to and is brought into contact with the anode electrode 112 of the membrane electrode assembly 110. The cathode-side separator 122 is opposed to and is brought into contact with the cathode electrode 113 of the membrane electrode assembly 110.

In a surface at an anode electrode 112 side in the anode-side separator 121, a flow path through which a hydrogen gas to be supplied to the anode electrode 112 circulates is formed. In a surface at a cathode electrode 113 side in the cathode-side separator 122, a flow path through which the air to be supplied to the cathode electrode 113 circulates is formed. The anode-side separator 121 and the cathode-side separator 122 that are adjacent to each other are bonded together by an adhesive or welding, for example, and are integrated. A flow path through which cooling water circulates is formed between the anode-side separator 121 and the cathode-side separator 122 that are bonded to each other.

The fuel cell 100 includes a frame portion 130 that outwardly projects from an outer peripheral portion of the membrane electrode assembly 110. Specifically, the frame portion 130 outwardly projects from an outer peripheral portion of the electrolyte membrane 111 of the membrane electrode assembly 110. For example, in a case where the electrolyte membrane 111 is formed at the central side of a resin film, a portion of the resin film that is at an outer peripheral side from the electrolyte membrane 111 corresponds to the frame portion 130. Further, the range in the resin film in which the electrolyte membrane 111 is formed may be extended to the outer peripheral side further than the range that is opposed to the anode electrode 112 and the cathode electrode 113. In this case, the portion in the electrolyte membrane 111 that is at the outer peripheral side from the range that is opposed to the anode electrode 112 and the cathode electrode 113 corresponds to a part of the frame portion 130.

The separators 120 are also disposed at both sides of the frame portion 130, similar to the membrane electrode assembly 110. Specifically, the separator 120 extends to the outer peripheral side further than the membrane electrode assembly 110. Further, the frame portion 130 is sandwiched by the anode-side separator 121 and the cathode-side separator 122.

In FIG. 2, the illustration of the end plates 22 in the clamping members 20 is omitted. As illustrated in FIG. 2, a groove 21a and a groove 21b are formed in a surface at a laminated body 10 side in the insulator 21. The groove 21a is disposed at the central side in the surface at the laminated body 10 side in the insulator 21. The groove 21a has a substantially rectangular shape, for example. The groove 21b is formed in an annular shape so as to surround the groove 21a. Note that, the cross-sectional shapes of the groove 21a and the groove 21b are not limited to those in the example in FIG. 2.

The terminal plate 23 is provided in the groove 21a of the insulator 21. The terminal plate 23 is fixed to the insulator 21. The terminal plate 23 has a substantially rectangular flat-plate shape. The terminal plate 23 is opposed to the membrane electrode assembly 110 of the fuel cell 100 that is positioned at the end portion in the laminated direction D1 in the laminated body 10 by sandwiching the separator 120 therebetween. The separator 120 that is adjacent to the clamping member 20 including the terminal plate 23 is brought into contact with a surface at the laminated body 10 side in the relevant terminal plate 23, in the laminated direction D1.

An elastic seal member 50 is provided in the groove 21b of the insulator 21. The elastic seal member 50 is fixed to the insulator 21. The elastic seal member 50 is formed in an annular shape so as to surround an outer peripheral portion of the terminal plate 23. The elastic seal member 50 is elastically deformable in the laminated direction D1. The elastic seal member 50 is made of rubber, for example. Further, the elastic seal member 50 only needs to have elasticity, and a material for the elastic seal member 50 is not specially limited. The separator 120 that is adjacent to the clamping member 20 to which the elastic seal member 50 is provided is brought into contact with a surface at the laminated body 10 side in the relevant elastic seal member 50, in the laminated direction D1.

The sealing performance between the elastic seal member 50 and the separator 120 is secured by the elastic deformation of the elastic seal member 50 in the laminated direction D1. In this manner, the elastic seal member 50 is interposed between the separator 120 that is adjacent to the clamping member 20, and the clamping member 20. Accordingly, the sealing performance between the clamping member 20 and the separator 120 is secured, and a gas and a refrigerant are prevented from leaking out from between the clamping member 20 and the separator 120.

In the example of FIG. 2, the elastic seal member 50 is provided to the insulator 21. Further, the elastic seal member 50 only needs to be provided to the clamping member 20. In other words, the elastic seal member 50 may be provided to a member of the clamping member 20 other than the insulator 21. For example, the elastic seal member 50 may be provided to the end plate 22.

In the frame portion 130 of the fuel cell 100, a bead seal 60 is formed in order to secure the sealing performance between the frame portion 130 and the separator 120. In the example of FIG. 2, the bead seals 60 are formed in portions that are brought into contact with the separators 120, on both surfaces of each of the fuel cells 100a, 100b, 100d, 100e, and 100g. Note that, instead of the bead seal 60, an elastic seal member 70 is provided to a single-side surface of a part of the fuel cells 100 (in the example of FIG. 2, the fuel cells 100c and 100f). This will be described later.

The bead seal 60 is a layer that is formed to a surface of the frame portion 130 and is made of rubber. The bead seal 60 is formed so as to protrude in the laminated direction D1 with respect to the other portions on the surface of the frame portion 130. In a contact location of the bead seal 60 formed to the frame portion 130 to the separator 120, the separator 120 is brought into contact with the bead seal 60 in the laminated direction D1 to secure the sealing performance between the frame portion 130 and the separator 120. In such a contact location, the sealing performance between the frame portion 130 and the separator 120 is secured by the deformations of the separator 120 and the bead seal 60 in the laminated direction D1. Accordingly, in a location where the bead seal 60 is provided, the sealing performance between the frame portion 130 and the separator 120 is secured, and a gas and a refrigerant are prevented from leaking out from between the frame portion 130 and the separator 120. Note that, a layer made of plastic may be formed on the surface of the frame portion 130. In this case, the bead seal 60 is formed on the surface of the layer made of plastic.

In the fuel cell stack 1, in addition to the elastic seal member 50 that is provided to the clamping member 20, the elastic seal member 70 is also provided to the frame portion 130 of at least one of the fuel cells 100. The relevant elastic seal member 70 is interposed between the separator 120 that is adjacent to the relevant frame portion 130, and the relevant frame portion 130. In the example of FIG. 2, the two fuel cells 100 to which no elastic seal member 70 is provided, and the one fuel cell 100 to which the elastic seal member 70 is provided, are alternately arranged. In other words, in the laminated direction D1, the elastic seal member 70 is provided for every three fuel cells 100. Specifically, no elastic seal member 70 is provided to the frame portions 130 of the fuel cells 100a and 100b, but the elastic seal member 70 is provided to the frame portion 130 of the fuel cell 100c. Moreover, no elastic seal member 70 is provided to the frame portions 130 of the fuel cells 100d and 100e, but the elastic seal member 70 is provided to the frame portion 130 of the fuel cell 100f.

As mentioned above, the bead seals 60 are respectively formed to portions that are brought into contact with the separators 120, on both surfaces of the frame portion 130 of the fuel cell 100 to which no elastic seal member 70 is provided. In contrast, in the fuel cell 100 to which the elastic seal member 70 is provided, the bead seal 60 is formed to one of the surfaces, and the elastic seal member 70 is provided to the other surface.

Further, the elastic seal members 70 may be provided to both surfaces in the fuel cell 100 to which the elastic seal member 70 is provided as well. Moreover, in the example of FIG. 2, in the fuel cell 100c and the fuel cell 100f, the elastic seal member 70 is provided to the surface at the same side (specifically, the surface at the right side in FIG. 2). Further, in the plurality of the fuel cells 100 to which the elastic seal members 70 are respectively provided, a pair of the fuel cells 100 in which orientations of the surfaces to which the elastic seal members 70 are respectively provided are different from each other may be present. Moreover, the ratio of the number of the fuel cells 100 to which the elastic seal members 70 are respectively provided with respect to the total number of the fuel cells 100 included in the laminated body 10 is not limited to that in the example of FIG. 2. Moreover, the arrangement of the fuel cells 100 to which the elastic seal members 70 are respectively provided is not limited to that in the example of FIG. 2, and the fuel cells 100 may be arranged at unequal intervals in the laminated direction D1, for example.

The elastic seal member 70 is fixed to the frame portion 130. Note that, in a case where a layer made of plastic is formed to the surface of the frame portion 130, the elastic seal member 70 is fixed to the layer made of plastic. The elastic seal member 70 is formed in an annular shape so as to surround the outer peripheral portion of the membrane electrode assembly 110. The elastic seal member 70 is elastically deformable in the laminated direction D1, similar to the elastic seal member 50. The elastic seal member 70 is made of rubber, for example, similar to the elastic seal member 50. Further, the elastic seal member 70 only needs to have elasticity, and a material for the elastic seal member 70 is not specially limited. The separator 120 that is adjacent to the frame portion 130 to which the elastic seal member 70 is provided is brought into contact with the relevant elastic seal member 70, in the laminated direction D1.

The sealing performance between the elastic seal member 70 and the separator 120 is secured by the elastic deformation of the elastic seal member 70 in the laminated direction D1. In this manner, the elastic seal member 70 is interposed between the separator 120 that is adjacent to the frame portion 130 to which the relevant elastic seal member 70 is provided, and the relevant frame portion 130. Accordingly, in a location where the elastic seal member 70 is provided, the sealing performance between the frame portion 130 and the separator 120 is secured, and a gas and a refrigerant are prevented from leaking out from between the frame portion 130 and the separator 120.

Here, the length of each of the elastic seal member 50 and the elastic seal member 70 in the laminated direction D1 is longer than the length of the bead seal 60 in the laminated direction D1. Further, the deformation amount of each of the elastic seal member 50 and the elastic seal member 70 are larger than the deformation amount of the bead seal 60. Specifically, the abovementioned deformation amount indicates the deformation amount of each member in a state where a fastening load in the laminated direction D1 is applied to the laminated body 10. In other words, in a case where the same compression load is applied, the deformation amount of each of the elastic seal member 50 and the elastic seal member 70 is larger than the deformation amount of the bead seal 60. Note that, the length of the elastic seal member 50 in the laminated direction D1 and the length of the elastic seal member 70 in the laminated direction D1 may match each other or may be different from each other. Moreover, the deformation amount of the elastic seal member 50 and the deformation amount of the elastic seal member 70 may match each other or may be different from each other.

Meanwhile, the fuel cell stack 1 is manufactured in such a manner that the plurality of the fuel cells 100 are laminated to form the laminated body 10, and the laminated body 10 is clamped in the laminated direction D1 by the pair of the clamping members 20, 20. There is a limitation on the processing accuracy of each component, and the size of each component varies within a size tolerance. Therefore, in a manufacturing process of the fuel cell stack 1, there is a possibility that a gap is generated in a location where the sealing performance has to be secured, due to the variation in the size of each component. In the present embodiment, the variation in the size of each component is absorbed by the deformations of the elastic seal member 50 and the elastic seal member 70, and the generation of a gap is suppressed. Accordingly, the sealing performance of the fuel cell stack 1 is improved.

In particular, in the present embodiment, as mentioned above, the elastic seal member 70 is also provided to the frame portion 130 of at least one of the fuel cells 100, and the relevant elastic seal member 70 is interposed between the separator 120 that is adjacent to the relevant frame portion 130, and the relevant frame portion 130. Here, in the layered bead seal 60 that is formed to the surface of the frame portion 130, the maximum deformation amount is small, and the absorbability for the variation in the size of each component is not extremely high. Therefore, supposing that it is a case where no elastic seal member 70 is provided to the frame portion 130 of any of the fuel cells 100, the variation in the size of each component is not completely absorbed, and there is a possibility that a gap is generated in a location where the sealing performance has to be secured. In contrast, in the present embodiment, the variation in the size of each component can be sufficiently absorbed by the elastic seal member 70, so that it is possible to appropriately improve the sealing performance of the fuel cell stack 1. Note that, in a case where all the bead seals 60 have been replaced with the elastic seal members 70, by considering concerns such as an increase in the processing cost and an excessive increase in a load to be applied to the laminated body 10, it can be said that the bead seal 60 needs to be used together.

Moreover, in the present embodiment, the elastic seal member 50 and the elastic seal member 70 are disposed at positions that overlap each other when seen in the laminated direction D1. For example, in the example of FIG. 2, a projection surface of the elastic seal member 50 into the laminated direction D1 and a projection surface of the elastic seal member 70 into the laminated direction D1 match each other. Further, the case where the elastic seal member 50 and the elastic seal member 70 are disposed at positions that overlap each other when seen in the laminated direction D1 also includes the case where the elastic seal member 50 and the elastic seal member 70 partially overlap each other when seen in the laminated direction D1. In other words, the projection surface of the elastic seal member 50 into the laminated direction D1 and the projection surface of the elastic seal member 70 into the laminated direction D1 may partially overlap each other. In this manner, the elastic seal member 50 and the elastic seal member 70 are disposed at positions that overlap each other when seen in the laminated direction D1, so that it is possible to effectively absorb the variation in the size of each component of the fuel cell stack 1 by the deformations of the elastic seal member 50 and the elastic seal member 70, and effectively improve the sealing performance of the fuel cell stack 1. Note that, the bead seals 60 are also disposed at positions that overlap the elastic seal member 50 and the elastic seal member 70 when seen in the laminated direction D1. Accordingly, the sealing performance between the bead seal 60 and the separator 120 is appropriately secured.

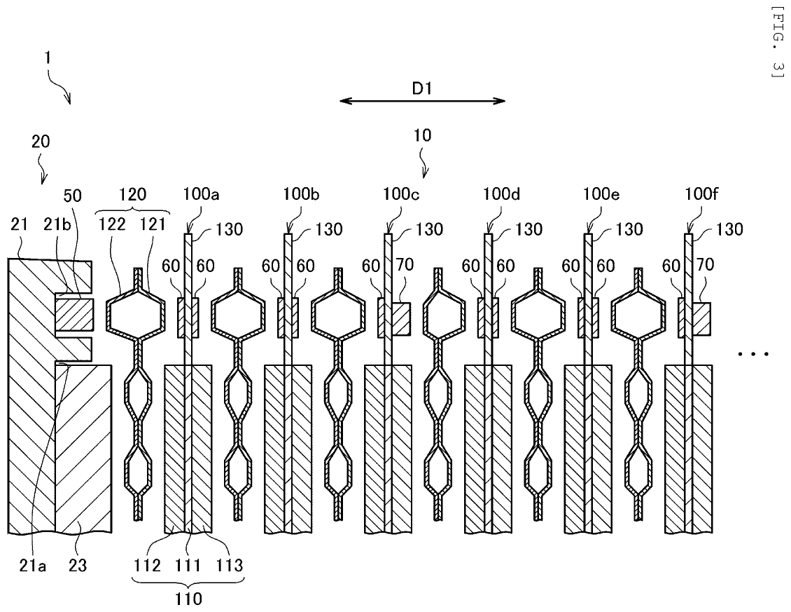

FIG. 3 is a view illustrating a separation state of the fuel cell stack 1. Specifically, FIG. 3 illustrates a state where separable portions in the laminated body 10 are separated in the fuel cell stack 1. Inseparable portions in the laminated body 10 are portions that are fixed to each other by bonding and the like. As illustrated in FIG. 3, each of the separators 120 is separable with respect to the clamping member 20, the membrane electrode assembly 110, and the frame portion 130. As mentioned above, in the fuel cell stack 1 in an assembled state, the separator 120 is brought into contact with the frame portion 130 to secure the sealing performance between the frame portion 130 and the separator 120. Here, the laminated body 10 is clamped in the laminated direction D1 by the pair of the clamping members 20, 20 to bring the separator 120 into contact with the frame portion 130. In this manner, the separator 120 is brought into contact with the frame portion 130 in a separable state. Accordingly, in the separation state of the fuel cell stack 1, each of the separators 120 can be separated, so that the maintenance performance of the separators 120, and components (in other words, the membrane electrode assembly 110 and the frame portion 130) sandwiched by the separators 120 is improved. For example, the replacement of these components that are separated from each other becomes easy.

Note that, although the example in which the bead seal 60 is formed to the surface of the frame portion 130 has been described in the above, the bead seal 60 may be formed to a portion in the surface of the separator 120 that is brought into contact with the frame portion 130. In this case as well, similar to the abovementioned example, in a location where the bead seal 60 is provided, the sealing performance between the frame portion 130 and the separator 120 is secured, and a gas and a refrigerant are prevented from leaking out from between the frame portion 130 and the separator 120.

Moreover, although the example in which the elastic seal member 70 is provided to the frame portion 130 of at least one of the fuel cells 100 has been described in the above, the elastic seal member 70 may be provided to the separator 120 that is adjacent to the frame portion 130. In this case as well, similar to the abovementioned example, it is possible to appropriately improve the sealing performance of the fuel cell stack 1.

### (Effects)

Effects of the fuel cell stack 1 according to the first embodiment of the invention will be described.

In the fuel cell stack 1, the elastic seal member 50 that is elastically deformable in the laminated direction D1 is provided to the clamping member 20, and the relevant elastic seal member 50 is interposed between the separator 120 that is adjacent to the clamping member 20, and the clamping member 20. Moreover, the elastic seal member 70 is also provided to the frame portion 130 of at least one of the fuel cells 100 or the separator 120 that is adjacent to the relevant frame portion 130, and the relevant elastic seal member 70 is interposed between the separator 120 that is adjacent to the relevant frame portion 130, and the relevant frame portion 130. In other words, in addition to providing the elastic seal member 50 to the clamping member 20, the elastic seal member 70 is provided to the frame portion 130 of at least one of the fuel cells 100 or the separator 120 that is adjacent to the relevant frame portion 130. Accordingly, the variation in the size of each component in the fuel cell stack 1 can be absorbed by the deformations of the elastic seal member 50 and the elastic seal member 70. In particular, supposing that it is compared with the case where no elastic seal member 70 is provided as the above, the variation in the size of each component in the fuel cell stack 1 can be sufficiently absorbed. Therefore, it is possible to improve the sealing performance of the fuel cell stack 1.

Preferably, in the fuel cell stack 1, the plurality of the elastic seal members 50, 70 are disposed at positions that overlap each other when seen in the laminated direction D1. Accordingly, it is possible to effectively absorb the variation in the size of each component of the fuel cell stack 1 by the deformations of the elastic seal member 50 and the elastic seal member 70, and effectively improve the sealing performance of the fuel cell stack 1.

Preferably, in the fuel cell stack 1, the separator 120 is brought into contact with the frame portion 130 in a separable state. Accordingly, the maintenance performance of each component in the fuel cell stack 1 is improved.

### Second Embodiment

A fuel cell stack 1A according to a second embodiment of the invention will be described.

### (Configuration)

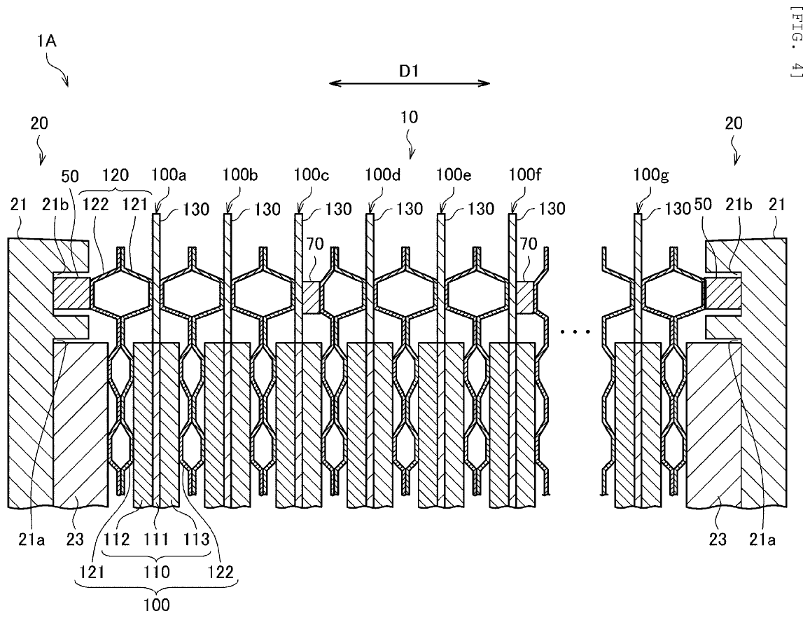

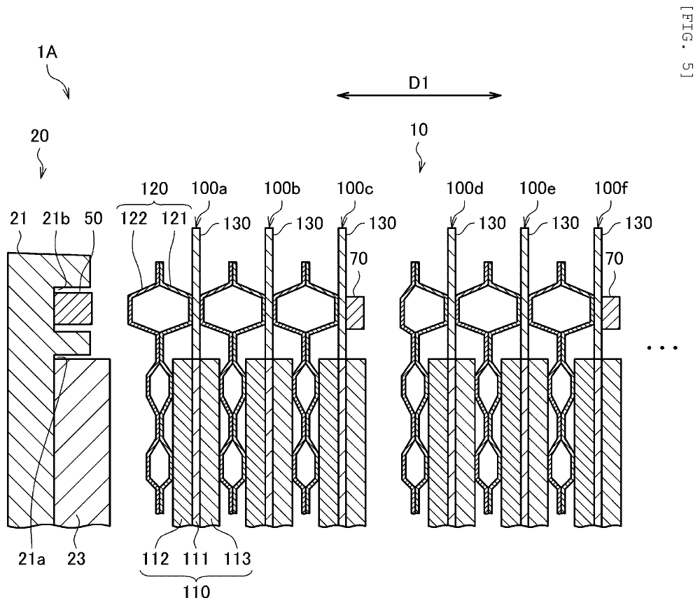

With reference to FIGS. 4 and 5, a configuration of the fuel cell stack 1A according to the second embodiment of the invention will be described.

FIG. 4 is a cross-sectional view illustrating the schematic configuration of the fuel cell stack 1A. In the fuel cell stack 1A, similar to the above-mentioned fuel cell stack 1, the elastic seal member 70 is provided to the frame portion 130 of a part of the fuel cells 100, and the relevant elastic seal member 70 is interposed between the separator 120 that is adjacent to the frame portion 130 to which the relevant elastic seal member 70 is provided, and the relevant frame portion 130. Accordingly, in a location where the elastic seal member 70 is provided, the sealing performance between the frame portion 130 and the separator 120 is secured, and a gas and a refrigerant are prevented from leaking out from between the frame portion 130 and the separator 120. In the example of FIG. 4, similar to the example of FIG. 2, the elastic seal members 70 are respectively provided to the frame portions 130 of the fuel cells 100c and 100f. Note that, in the fuel cell stack 1A as well, similar to the above-mentioned fuel cell stack 1, the elastic seal member 70 may be provided not to the frame portion 130 but to the separator 120.

Here, in the fuel cell stack 1A, unlike the above-mentioned fuel cell stack 1, in a location to which no elastic seal member 70 is provided, the separator 120 is bonded to the frame portion 130 in order to secure the sealing performance between the frame portion 130 and the separator 120. In the example of FIG. 4, the separators 120 are bonded to the frame portion 130, on both surfaces of each of the fuel cells 100a, 100b, 100d, 100e, and 100g. Moreover, in the fuel cells 100c and 100f to which the elastic seal members 70 are respectively provided, the separator 120 is bonded to a surface to which no elastic seal member 70 is provided in each fuel cell 100. Accordingly, in a location where the separator 120 is bonded to the frame portion 130, the sealing performance between the frame portion 130 and the separator 120 is secured, and a gas and a refrigerant are prevented from leaking out from between the frame portion 130 and the separator 120. Note that, although an adhesive is actually interposed between the members that are bonded to each other, the illustration of the adhesive is omitted in FIG. 4 and FIG. 5, which is described later.

In the fuel cell stack 1A, the separator 120 is bonded to the frame portion 130, unlike the above-mentioned fuel cell stack 1, so that the bead seal 60 is not formed to the frame portion 130 of the fuel cell 100. The separators 120 are respectively bonded to the frame portions 130 in this manner to integrate the components that are included in the plurality of the fuel cells 100.

FIG. 5 is a view illustrating a separation state of the fuel cell stack 1A. Specifically, FIG. 5 illustrates a state where separable portions in the laminated body 10 are separated in the fuel cell stack 1A. As illustrated in FIG. 5, the components that are included in the plurality of the fuel cells 100 and are integrated in such a manner that the separators 120 are bonded to the frame portions 130, are inseparable. In the example of FIG. 5, the membrane electrode assemblies 110 and the frame portions 130 of the fuel cells 100a, 100b, and 100c are integrated with the three separators 120. Moreover, the membrane electrode assemblies 110 and the frame portions 130 of the fuel cells 100d, 100e, and 100f are integrated with the three separators 120.

As mentioned above, in the fuel cell stack 1A, the separators 120 are bonded to the frame portions 130, and the components that are included in the plurality of the fuel cells 100 are integrated. Here, unlike the fuel cell stack 1A, in a case where each of the separators 120 is separable with respect to the clamping member 20, the membrane electrode assembly 110, and the frame portion 130, in a manufacturing process of the fuel cell stack 1A, in order to secure the sealing performance in the fuel cell stack 1A, a large compression force to some extent in the laminated direction D1 needs to be applied in advance to the respective components that are included in the fuel cell stack 1A. In contrast, in the present embodiment, the components that are included in the plurality of the fuel cells 100 are integrated, so that it is possible to simplify the process of applying in advance the compression force in the laminated direction D1 to the respective components that are included in the fuel cell stack 1A, in the manufacturing process of the fuel cell stack 1A (for example, the compression force can be reduced). Moreover, the components that are included in the plurality of the fuel cells 100 are integrated to improve the rigidity of the fuel cell stack 1A.

### (Effects)

Effects of the fuel cell stack 1A according to the second embodiment of the invention will be described.

In the fuel cell stack 1A, similar to the above-mentioned fuel cell stack 1, the elastic seal member 50 that is elastically deformable in the laminated direction D1 is provided to the clamping member 20, and the relevant elastic seal member 50 is interposed between the separator 120 that is adjacent to the clamping member 20, and the clamping member 20. Moreover, the elastic seal member 70 is also provided to the frame portion 130 of at least one of the fuel cells 100 or the separator 120 that is adjacent to the relevant frame portion 130, and the relevant elastic seal member 70 is interposed between the separator 120 that is adjacent to the relevant frame portion 130, and the relevant frame portion 130. In other words, in addition to providing the elastic seal member 50 to the clamping member 20, the elastic seal member 70 is provided to the frame portion 130 of at least one of the fuel cells 100 or the separator 120 that is adjacent to the relevant frame portion 130. Accordingly, an effect similar to that of the above-mentioned fuel cell stack 1 is exhibited, so that it is possible to improve the sealing performance of the fuel cell stack 1A.

In particular, in the fuel cell stack 1A, the separator 120 is bonded to the frame portion 130. Accordingly, it is possible to simplify the process of applying in advance the compression force in the laminated direction D1 to the respective components that are included in the fuel cell stack 1A, in the manufacturing process of the fuel cell stack 1A. Moreover, the rigidity of the fuel cell stack 1A is improved.

In the foregoing, the preferred embodiments of the invention have been described with reference to the attached drawings, however, the invention is naturally not limited to the abovementioned embodiments, and it is needless to say that various kinds of variations or modifications within the range of the scope of the claims belong to the technical range of the invention.

### REFERENCE SIGNS LIST

1: Fuel cell stack
1A: Fuel cell stack
10: Laminated body
20: Clamping member
21: Insulator
21a: Groove
21b: Groove
22: End plate
23: Terminal plate
31: Fuel gas supply hole
32: Oxidation gas supply hole
33: Refrigerant supply hole
41: Fuel gas exhaust hole
42: Oxidation gas exhaust hole
43: Refrigerant exhaust hole
50: Elastic seal member
60: Bead seal
70: Elastic seal member
100: Fuel cell
100a: Fuel cell
100b: Fuel cell
100c: Fuel cell
100d: Fuel cell
100e: Fuel cell
100f: Fuel cell
100g: Fuel cell
110: Membrane electrode assembly
111: Electrolyte membrane
112: Anode electrode
113: Cathode electrode
120: Separator
121: Anode-side separator
122: Cathode-side separator
130: Frame portion
D1: Laminated direction

1. A fuel cell stack (1, 1A) comprising: a laminated body (10) in which a plurality of fuel cells (100) are laminated, each fuel cell including a membrane electrode assembly (110) that includes an electrolyte membrane (111), an anode electrode (112), and a cathode electrode (113), and separators (120) that are disposed at both sides of the membrane electrode assembly (110); and a pair of clamping members (20) that clamp the laminated body (10) in a laminated direction (D1) of the laminated body (10), wherein
the fuel cell (100) includes a frame portion (130) that outwardly projects from an outer peripheral portion of the membrane electrode assembly (110), the separators (120) being disposed at both sides of the frame portion (130),
an elastic seal member (50) that is elastically deformable in the laminated direction (D1) is provided to each clamping member (20), and the respective elastic seal member (50) is interposed between the separator (120) that is adjacent to the clamping member (20), and the clamping member (20), and
another elastic seal member (70) is also provided to the frame portion (130) of at least one of the fuel cells (100) or the separator (120) that is adjacent to the respective frame portion (130), and the respective another elastic seal member (70) is interposed between the separator (120) that is adjacent to the respective frame portion (130), and the respective frame portion (130).

2. The fuel cell stack according to claim 1, wherein the elastic seal members (50, 70) are disposed at positions that overlap each other when viewed in the laminated direction (D1).

3. The fuel cell stack according to claim 1, wherein each separator (120) is brought into contact with the respective frame portion (130) in a separable state.

4. The fuel cell stack according to claim 1, wherein each separator (120) is bonded to the respective frame portion (130).

5. The fuel cell stack according to claim 2, wherein each separator (120) is brought into contact with the respective frame portion (130) in a separable state.

6. The fuel cell stack according to claim 2, wherein each separator (120) is bonded to the respective frame portion (130).
